(19) United States
(12) Patent Application Publication
(10) Pub. No.: US 2025/0198199 A1
(43) Pub. Date: Jun. 19, 2025

(54) Cylinder and control component

(71) Applicant: Incubico Limited, Tortola (VG)

(72) Inventor: Wai Cheuk Raymond IP, Kowloon (HK)

(21) Appl. No.: 18/995,952

(22) PCT Filed: Jul. 9, 2018
(86) PCT No.: PCT/CN2018/094942

§ 371 Date: Jan. 17, 2025

(51) Int. Cl. E05B 47/00; E05B 17/20

(52) U.S. Cl. CPC E05B 47/0012; E05B 17/2003; E05B 2047/002

(57) ABSTRACT

The present invention discloses a cylinder and a control component and relates to the field of locks, comprising two mirror-symmetric cylinder mechanisms (B) which jointly drive a latchbolt control ring (1), wherein the cylinder mechanisms (B) comprise an electric locking ring (2, 9) and a control pillar (8, 11), wherein each of the two control pillars (8, 11) is equipped with a first control pin (71) and a second control pin (72), wherein the first control pin (71) and the second control pin (72) circulates around the rotatable shaft (81), wherein the rotation direction, in which the first control pins (71) controls the latchbolt control ring (1) to unlatch, corresponds to the rotation direction, in which the second control pin (72) controls the latchbolt control ring (1) to unlatch. The present invention enables equal operations on both sides of a door, and that the separate operation on both sides of the door does not interfere with each other. Furthermore, only one cylinder is required, which simplifies the structure and a single motor realizes a not-interfered alternating output on both sides of the door.

### TECHNICAL FIELD

The present invention relates to the field of locks, particularly, cylinders and control components.

### BACKGROUND ART

Existing mechanical locks distinguish inside and outside by design to realize a distinction between private and public spaces, causing an identical operation on both sides not possible. The existing locks are designed with locking capabilities on one side and without on the other, and switching sides of operation is not allowed. Resulting in existing locks being provided with only one form of usage and an adjustment according to the actual situations is not allowed.

When such a locking device is applied in a shared area, with only unidirectional operations are allowed, is unfavorable to the sharing of the space. The subject door cannot be locked both ways when security and privacy is needed for either directions. For example, the double door security adopted in secured facilities such as banks, the implementation of such systems utilizing existing locks is complicated and the choice of the types of doors applicable is limited.

### DISCLOSURE OF INVENTION

The object of the invention is to provide a cylinder and a control component, allowing equal operation on both sides. Each separate operation on both sides of the door does not disturb each other. With only one cylinder provided, a simple structure is provided and only one motor is required to control the switch on both sides, resulting in smaller volume and simpler structure.

The object is achieved by the following subject matter of the present invention:
A cylinder, comprising two mirror-symmetric cylinder mechanisms which jointly drive a latchbolt control ring;
wherein the latchbolt mechanism comprises an electric locking ring and a control pillar, wherein the control pillar passes through the rotation centers of the electric locking ring and the latchbolt control ring one after another;
wherein one of the two control rods is provided at its front surface with a rotatable shaft and the other is provided at the front surface with a counter bore, wherein the rotatable shaft is inserted into the counter bore and may rotate inside it, wherein the rotatable shaft passes movably through the latchbolt control ring and the latchbolt control ring may rotate around the rotatable shaft;
wherein each of the two control rods is equipped with a first control pin and a second control pin, wherein the first control pin and the second control pin circulates around the rotatable shaft, wherein the rotation direction, in which the first control pins controls the latchbolt control ring to unlatch, corresponds to the rotation direction, in which the second control pin controls the latchbolt control ring to unlatch;
wherein the first control pin passes in sequence through the electrical unlocking cam of the first mirror symmetric side, the mechanical locking ring of the first mirror symmetric side, the electrical locking ring of the first mirror symmetric side, the latchbolt control ring and the electrical locking ring of the second mirror symmetric side, wherein the electrical locking ring of the second side controls the unlocking and locking movement of the first control pin and the electrical locking ring of the first mirror symmetric side does not limit the unlatching movement of the first control pin;
wherein the second control pin passes in sequence through the electrical unlocking cam of the second mirror symmetric side, the mechanical locking ring of the second mirror symmetric side, the electrical locking ring of the second mirror symmetric side, the latchbolt control ring and the electrical locking ring of the first mirror symmetric side, wherein the electrical locking ring of the first mirror side controls the unlocking and locking movement of the second control pin and the electrical locking ring of the second mirror side does not limit the unlatching movement of the second control pin.

The cylinder is further defined in that the cylinder mechanism may comprise a mechanical locking ring, wherein the mechanical locking ring and the control pillar rotate synchronously.

The cylinder is further defined in that the cylinder mechanism may comprise an elastic resetting part, wherein the elastic resetting part and the control pillar form a rotational torque and the elastic resetting part tights the electrical locking ring in an opposite direction of unlatching.

The cylinder is further defined in that the first control pin and the second control pins have each a fan-shaped cross section, and the arc size of the fan shape is m;
wherein the electrical locking ring on the first mirror side is provided with two arc-shaped through holes, the arc size of one arc-shaped through hole is 2 m and the arc size of the other arc-shaped through hole is 3 m;
in case that the first control pin matches the arc-shaped through hole of the electrical locking ring on the first mirror side that has an arc size of 3 m, the first control pin may rotate at the same angle clockwise and anti-clockwise within the arc-shaped through hole of the electrical locking ring on the first mirror side without rotating the electrical locking ring on the first mirror side. When the first control pin in located in the middle of the arc-shaped through hole that has a 3 m arc size of the electrical locking ring on the first mirror side, the electrical locking ring is in the standby state;
in case that the first control pin matches the arc-shaped through hole of the latchbolt control ring that has an arc size of 2 m, the latchbolt control ring rotates therewith when the first control pin rotates in a direction of unlatching and the latchbolt control ring does not rotate therewith when the first control ring rotates with an arc size of m in an opposite direction of unlatching;
in case that the first control pin matches the arc-shaped through hole of the electrical locking ring on the second mirror side that has an arc size of 2 m, when the electrical locking ring (9) on the second mirror side is locked, the first control pin cannot rotate in a direction of unlatching, but rotate with an arc size of m in an opposite direction of unlatching.

A control component, comprising a cylinder and a motored locking mechanism, wherein the motored locking mechanism limits the rotational displacement of the electrical locking ring.

The control component is further defined in that the motored locking mechanism comprises a motor, two groups of transmission mechanisms that are arranged mirror symmetrically and two output components that are arranged mirror symmetrically, wherein the two groups of transmission mechanisms are driven by a common motor and the transmission mechanisms transmit power of the motor to the output components;
wherein an output end of the motor is provided with a driving gear, wherein the driving gear is attached to an output shaft of the motor;
wherein the two groups of transmission mechanisms further comprise each an input gear, wherein both input gears are designed as frontend gears, and wherein rotational shafts of both input gears are parallel to each other;
wherein one driving gear is engaged with both input gears, wherein the two input gears are spaced 180 degrees from each other on the circumference of the input gear.

The control component is further defined in that the transmission mechanism further comprises a middle gear and an output gear;
Wherein the input gear drives the middle gear to rotate, and wherein the middle gear and the output gear engage with each other.

The control components are further defined in that the middle gear comprises a first middle gear, a second middle gear and a third middle gear, wherein the input gear and the first middle gear are fixed coaxially, and wherein the first middle gear, the second middle gear, the third middle gear and the output gears engage with each other in sequence.

The control component is further defined in that the first middle gear is provided with a rotatable shaft, wherein on the rotatable shaft is fixed attached with an overrunning clutch, wherein the overrunning clutch is attached with the first middle gear.

The control component is further defined in that the third middle gear puts output to the output gear unidirectionally.

The control component is further defined in that the rotatable shaft is provided on a locking shell, wherein an overrunning clutch is attached to the rotatable shaft, wherein the third middle gear is further attached to the overrunning clutch.

The control component is further defined in that the output component is designed as a motored jamming hook, wherein one end of the motored jamming hook is designed as a hook end and the other end is a pin shaft connecting end, wherein the motored jamming hook is provided with an oval through hole, wherein the motored jamming hook swings around the pin shaft connecting end;
wherein the front end of the output gear is provided with an eccentric pillar, which passes through the oval through holes;
wherein the eccentric pillar circulates around a central shaft of the output gear when the output gear rotates, wherein the eccentric pillar drives the motored jamming hook to swing.

The control component is further defined in that the motored locking mechanism is provided with two mirror-symmetric automatic unlocking rings, wherein both mirror-symmetric automatic unlocking rings are driven by the two transmission mechanisms;
wherein the cylinder is provided with two mirror-symmetric electrical unlocking cams, wherein the electric unlocking cams and the control pillar rotate synchronously;
wherein the automatic unlocking rings trigger the electric unlocking cams to rotate when an extruding portion of the electric unlocking cams falls on the rotation track of the extruding portion of the automatic unlocking rings.

Compared with the prior art, the present invention has the following effects:
1. A double-sided independent operation can be performed so that both sides can be used as a public space or a private space.
2. A locked-in movement through the motored locking system to the cylinder mechanism benefits the realization of an automatic control. Since the motored locking system can only repeat being in a state that one-side is driven and the other side not, drive is realized through the positive and negative rotation of one motor, which enables a smaller volume and a simple structure.
3. Besides the function of the locking and unlocking the cylinder mechanism, the motored locking system can control the mechanical locking mechanism to remove the limit on the rotatable latchbolt in a state that the latchbolt is manually locked, such that the lever returns to the standby state and a state of a lockout during power failure is avoided.
4. Functions are provided abundant while the structure is compact and adapted to a wide range of application.
5. A unidirectional transmission of gears is adopted, such that a structure reliability is not easy to be affected by vibration.
6. A common rotatable latchbolt is utilized while a double-sided separated operation is enabled, which not only simplifies structure, but also improves function.
7. The electric locking mechanism is transferred to a periodical swing by the rotation movement, which reduces control errors, makes control easier and more precise.

### BRIEF DESCRIPTION OF DRAWING

The present invention is further described in conjunction with the non-limiting embodiments given by the figures, in which

FIG. 1 shows a schematic view of a lock according to one example of the present invention,

FIG. 2 shows a schematic view of a lock according to one example of the present invention when mounted on a door,

FIG. 3 shows schematically a disassembled view of a lock according to one example of the present invention,

FIG. 4 shows schematically an exploded view of a lock according to one example of the present invention,

FIG. 5 shows a schematic view of motions of the latchbolt mechanism E of a lock according to one example of the present invention,

FIG. 6 shows in a schematic view that the mechanical locking system D matches the cylinder mechanism B according to the present invention,

FIG. 7 shows in a process flow diagram an automatic unlocking when the motored locking system C matches the electrical unlocking cam 6,

FIG. 8 shows a schematic view of the motored locking system C and the electrical locking rings 2, 9,

FIG. 9 shows a schematic view of the cylinder mechanism B,

FIG. 10 shows in a schematic view that the latchbolt mechanism E matches the latchbolt accommodation mechanism according to another embodiment of the present invention,

FIG. 11 shows a schematic view of a latchbolt accommodating mechanism according to an embodiment of the present invention,

FIG. 12 shows a schematic view of a lock according to another embodiment of the present invention when mounted on a door;

FIG. 13 shows schematically a disassembled view of a lock according to another embodiment of the present invention,

FIG. 14 shows schematically an exploded view of a lock according to another embodiment of the present invention,

FIG. 15 shows a schematic view of motions of the latchbolt mechanism E of a lock according to another embodiment of the present invention,

FIG. 16 shows in a schematic view that the mechanical locking system D matches the cylinder mechanism B of a lock according to another embodiment of the present invention,

FIG. 17 shows in a schematic view that the latchbolt mechanism E matches the latchbolt accommodation mechanism of a lock according to another embodiment of the present invention,

FIG. 18 shows a perspective view of the latchbolt accommodation mechanism of a lock according to another embodiment of the present invention.

### BEST MODE FOR CARRYING OUT THE INVENTION

In order that those skilled in the art can better understand the present invention, the subject matter of the present invention is further illustrated in conjunction with figures and embodiments.

### First Embodiment

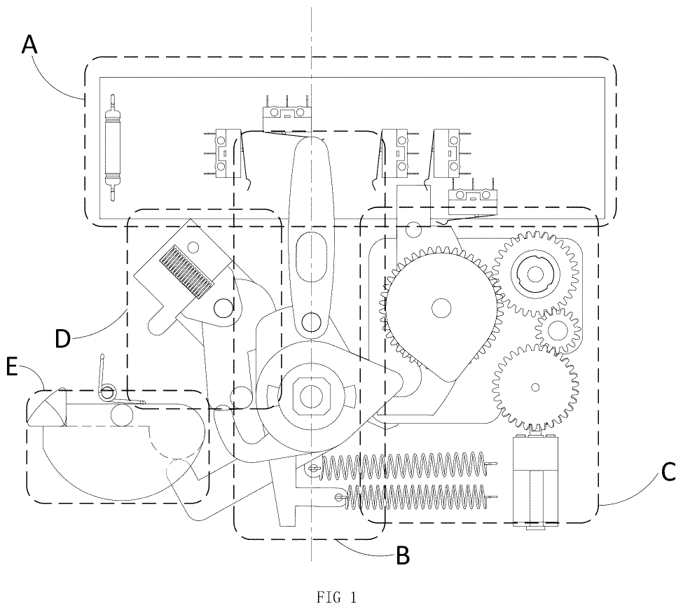

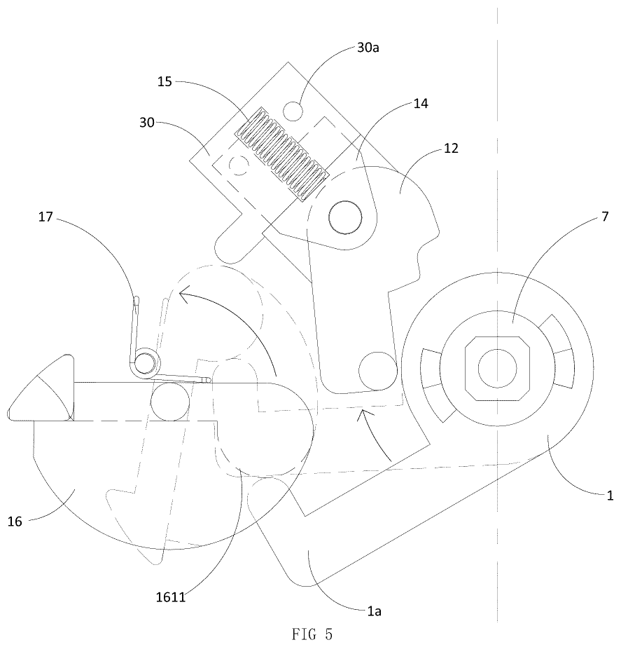

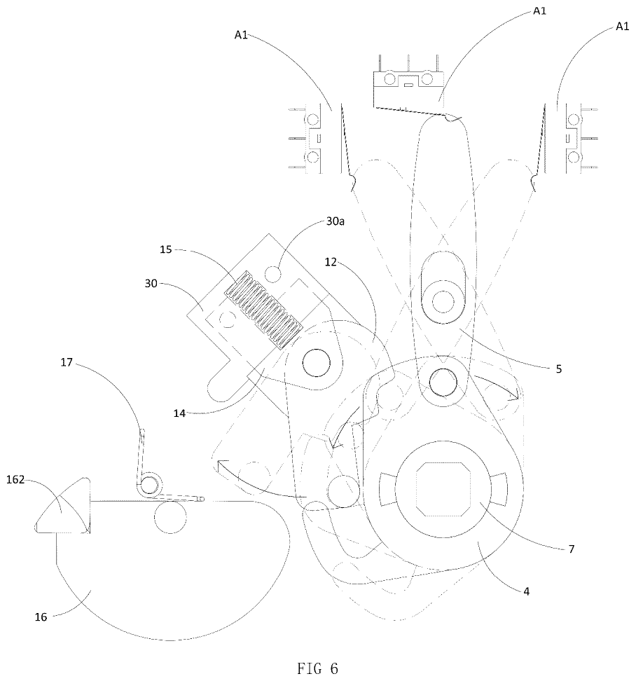

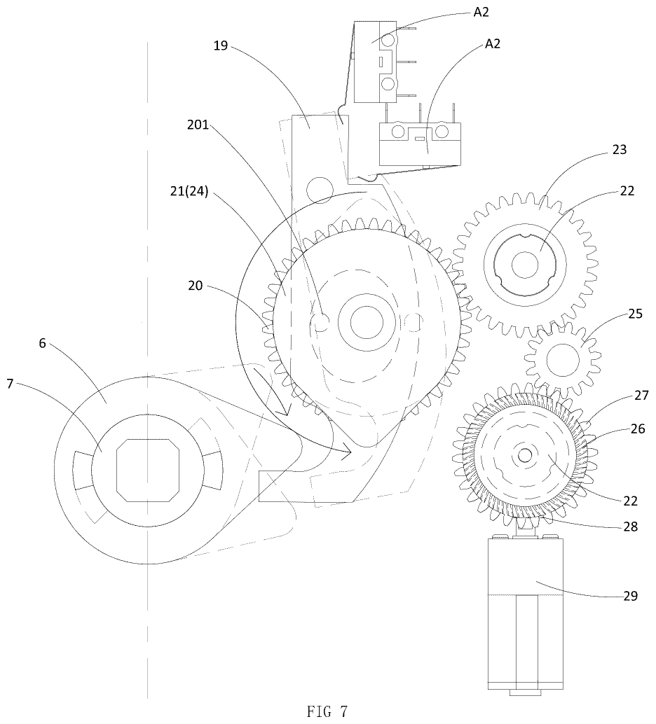

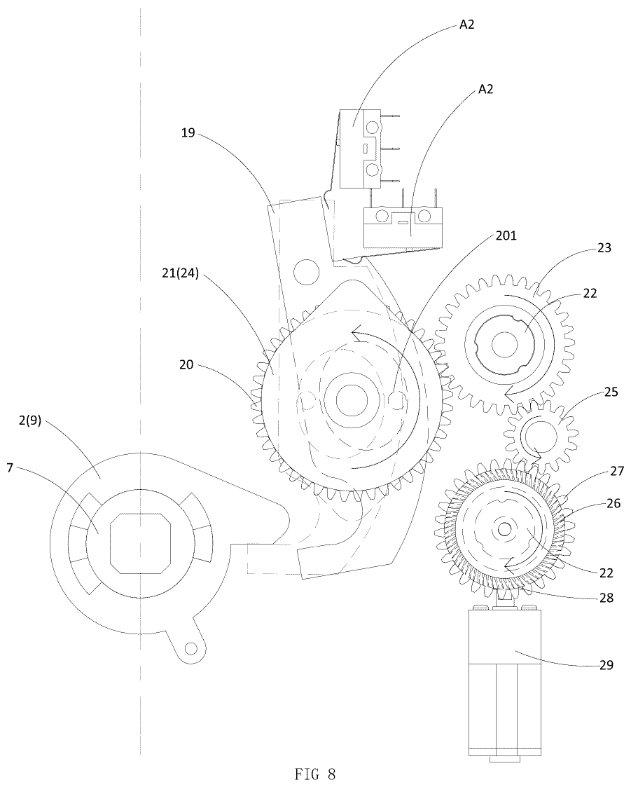

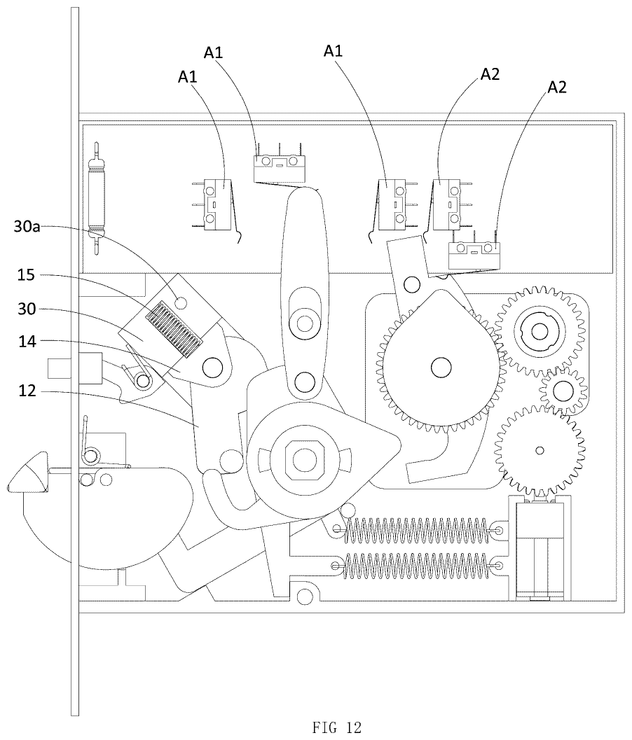

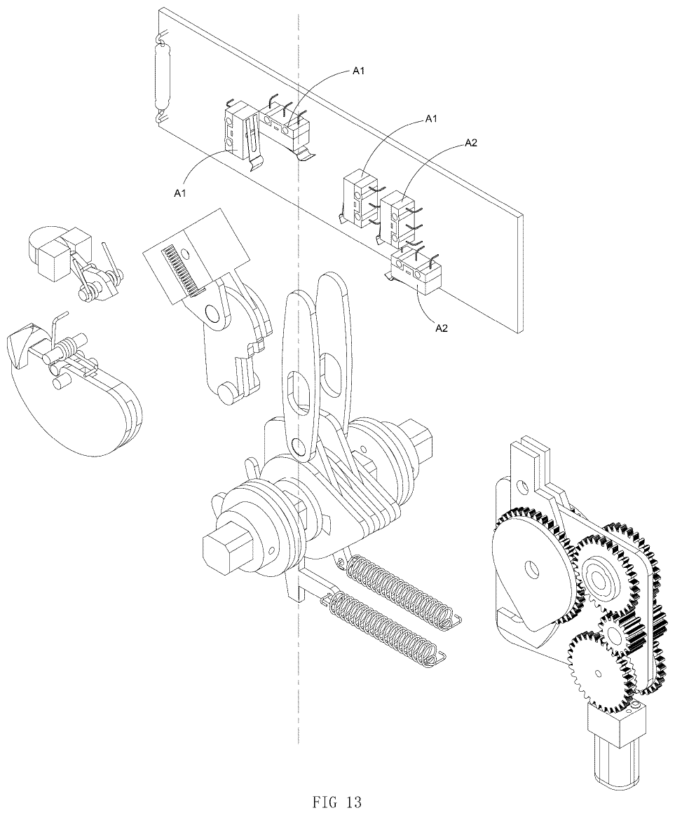

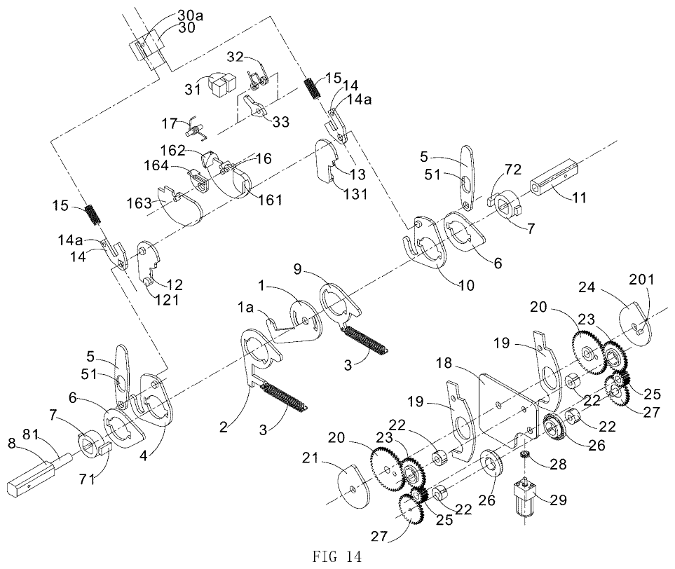

FIG. 1 to 14 show a lock that does not distinguish between public and private spaces, comprising two sub locking systems having the same structure, which are arranged mirror symmetrically, wherein each of the two sub locking systems comprises a cylinder mechanism B, a mechanical locking mechanism D and a motored locking system C, wherein two cylinder mechanisms drive together a same latchbolt mechanism E to move.

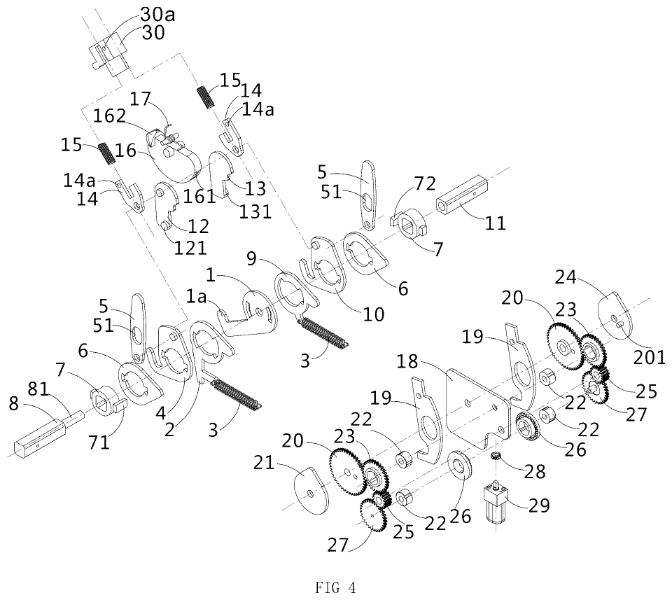

As shown in FIG. 1 to 6, the cylinder mechanism B comprises a latchbolt control ring 1, mechanical locking rings 4, 10, electrical locking rings 2, 9, control pillars 8, 11, an electrical unlocking cam 6 and an extension spring 3. The latchbolt control ring 1 controls and matches the latchbolt mechanism E. The extension spring 3 and the control pillars 8, 11 form a rotating torque and the extension spring strains the electrical locking rings 2, 9 in a direction opposite to unlocking. Two cylinder mechanisms B share one latchbolt control ring 1 and the control pillars 8, 11 are positioned on one same axis and are coaxially rotatable, as shown in FIG. 4.

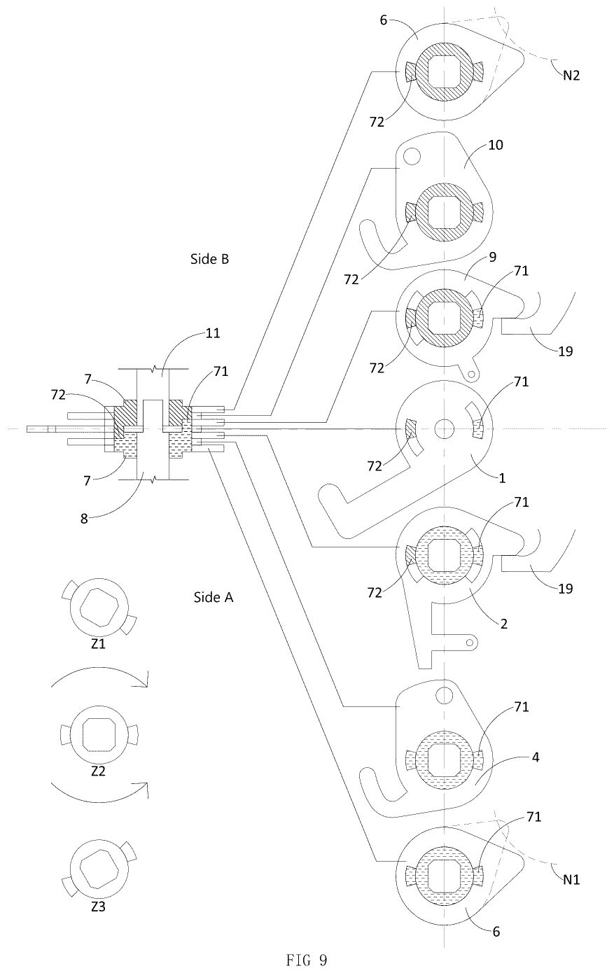

As shown in FIG. 4, the two control pillars 8, 11 have rectangular cross sections, and among the two control pillars 8, 11, one of the control pillars 8 is provided at its front surface with a rotatable rod 81 and the other control pillar 11 is provided at its front surface with a counterbore, wherein the rotatable rod 81 can rotate in the counterbore after the rotatable rod 81 is inserted into the counterbore. The rotatable rod 81 passes through the latchbolt control ring 1 movably, wherein the latchbolt control ring 1 can rotate around the rotatable rod 81. As shown in FIG. 9, N1 is a movement trajectory of an automatic unlocking ring 21 and N2 is a movement trajectory of an automatic unlocking ring 24. Z1 represents an unlocking state, Z2 represents a standby state and Z3 represents a state of locking the latchbolt manually. In FIG. 9, the lever rotates clockwise to change the state from Z2 to Z1, and then the lever rotates anticlockwise to change the state to Z3.

As shown in FIGS. 4 and 9, each of the control pillars 8, 11 is attached to control sleeves 7. The control pillars 8, 11 matches the control sleeves 7 through a spline, wherein each of the two control sleeves 7 is provided with a first control pin 71 and a second control pin 72 circulates around the rotatable rod 81 and the direction of the first control pin 71 that controls the latchbolt control ring 1 to unlock corresponds to the direction, in which the second control pin controls the latchbolt control ring to unlock.

As shown in FIGS. 4 and 9, the control sleeves 7 pass in sequence through the electrical unlocking cam 6 and the mechanical locking ring 4, wherein the control sleeves 7 each matches the electrical unlocking cam 6 and the mechanical locking ring 4 through the spline. The first control pin 71 passes in sequence through the electrical unlocking cam 6, the mechanical locking ring 4, the electrical locking ring 2, the latchbolt control ring 1 and the electrical locking ring 9, wherein the electrical locking ring 2 remains unrotated while the first control pin 71 rotates with the lever. The second control pin 71 passes in sequence through the electrical unlocking cam 6, the mechanical locking ring 10, the electrical locking ring 9, the latchbolt control ring 1 and the electrical locking ring 2, wherein the electrical locking ring 9 remains unrotated while the second control pin 72 rotates with the lever and when the latchbolt control ring 1 rotates, the electrical locking ring 2 rotates.

As shown in FIGS. 4 and 9, the first control pin 71 and the second control pin 71 both have fan-shaped cross sections, and the arc size of the fan shape is m. The electrical locking ring 2 is provided with two arc-shaped through holes, the arc size of one arc-shaped through hole is 2 m and the arc size of the other arc-shaped through hole is 3 m, wherein the electrical locking ring 9 and the electrical locking ring 2 are mirror symmetrical. In case that the first control pin 71 matches the arc-shaped through hole of the electrical locking ring 2 that has an arc size of 3 m, the first control pin 71 may rotate at the same angle clockwise and anti-clockwise within the arc-shaped through hole of the electrical locking ring 2. When the first control pin 71 in located in the middle of the arc-shaped through hole of the electrical locking ring 2 that has a 3 m arc size, the electrical locking ring 2 is in the standby state. In case that the first control pin 71 matches the arc-shaped through hole of the latchbolt control ring 2 that has an arc size of 2 m, when the first control ring 71 rotates in a direction of unlatching, the latchbolt control ring 1 rotates therewith and when the first control ring rotates with an arc size of m in an opposite direction of unlatching, the latchbolt control ring 1 does not rotate. In the case that the first control pin 71 matches the arc-shaped through hole of the electrical locking ring 9 that has an arc size of 2 m, when the electrical locking ring 9 is locked, the first control pin cannot rotate in a direction of unlatching, but rotates with an arc size of m in an opposite direction of unlatching. Since the second control pin 72 has a similar structure as the first control 71, a repetition is waived here.

As shown in FIGS. 4 and 9, a working process is described: when the electrical locking ring 2 is locked, the control pillar 11 cannot perform movements in the direction of unlatching and when the electrical locking ring 9 is locked, the control pillar 8 cannot perform movements in the direction of unlatching. The control pillars 8, 11 control the latchbolt control ring 1 separately and do not interfere with each other. The mechanical locking ring 4 and the control pillar 8 rotate synchronously and the mechanical locking ring 10 and the control pillar 11 rotate synchronously.

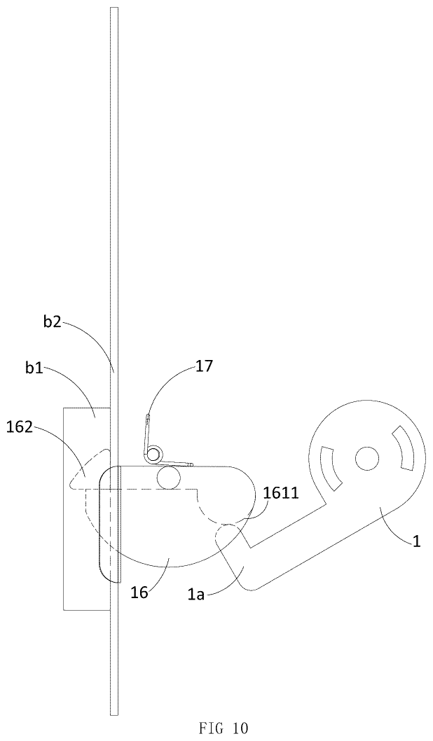

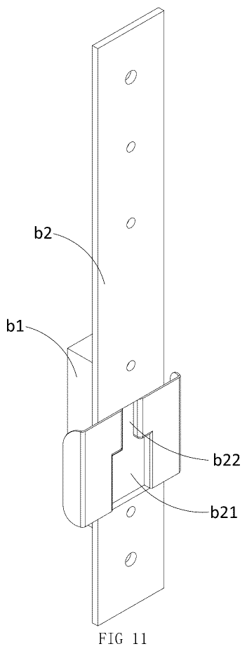

As shown in FIGS. 10 and 11, the latchbolt mechanism E comprises a rotatable latchbolt 16 and a torsion spring 17. The rotatable latchbolt 16 is provided with a rotatable pin rod, wherein the rotatable latchbolt 16 rotates around the rotatable pin rod. The torsion spring 17 controls the rotatable latchbolt 16 to stay in a closed state. The rotatable latchbolt 16 matches the latchbolt control ring 1. The rotatable latchbolt 16 is a plate-shaped structure and has a semicircular form. The rotatable latchbolt 16 has a guiding groove 161 and the latchbolt control ring 1 is provided with a hook 1a, which reaches inside the guiding groove 161. Inside the guiding groove 161, a jamming protuberance 1611 is provided, with which the hook 1a engages, and during the rotation of the rotatable latchbolt 16, while the hook 1a and the jamming protuberance 1611 rotate relatively, they also slide relatively.

The non-joint surface of a jamming block 162 and the rotatable latchbolt 16 is an inclined plane or a curved surface and the joint surface is the front end.

In the case that the non-joint plane of the jamming block 162 and the rotatable latchbolt 16 is an inclined plane, there are at least three of the inclined planes and two of them are mirror symmetrically formed, and the other inclined plane connects the two mirrored symmetrically formed inclined planes.

FIGS. 10 and 11 show a latchbolt receiving mechanism that matches the latchbolt mechanism E, comprising a receiving chamber b1 and a cover plate b2, wherein the chamber opening of the receiving chamber b1 is covered by the cover plate b2. The cover plate b2 is provided with a first through hole b21 and a second through hole b22. The jamming block 162 is rotatably inserted into the first through hole b21 and the rotatable latchbolt is inserted rotatably into the second through hole b22. The first through hole b21 has a rectangular opening and the second through hole b22 has a rectangular opening, wherein the first through hole b21 and the second through hole b22 form an inverse convex shape.

Working process is described as follows: In a locked state, the jamming block 162 lies inside the receiving chamber b1. The torsion spring 17 exerts pressure on the rotatable latchbolt 16 in such a way that the rotatable latchbolt 16 tends to rotate clockwise. The end of the hook 1a reaches into the guiding groove 161. When the hook la interacts with the jamming block 162 and rotates clockwise, the rotatable latchbolt 16 rotates anticlockwise. The jamming block 162 rotates out of the through hole b21 and into the door panel and thus pushes the door panel to achieve the door-opening movement. The above working process described above also applies to a required door-closing movement.

Characteristics of the latchbolt mechanism E are: 1. Movements of opening and closing are realized by rotating and thus an unintentional incorrect operation in an unnatural circumstance is avoided. 2. Due to the arrangement of the jamming block, the rotatable latchbolt is jammed after it rotatably enters into the receiving chamber. An opening movement can only be performed by rotating in an opposite direction, so that a more reliable locking state is realized. 3. A rotatable latchbolt with a plate structure has a wide width, which means that more shear force can be absorbed in the event of a forced breakthrough. 4. It applies for sliding doors, folding doors and so on. It is realized that setting of the latchbolt direction is avoided when switching the opening direction of a door, in other words, the operation to switch the opening direction of a door is equal in each of the two directions.

FIG. 1 to 8 show a mechanical locking system D and an electrical locking system C. The mechanical locking system D matches the mechanical locking rings 4, 10, wherein the electrical locking system C matches the electrical locking rings 2, 9.

As shown in FIG. 1 to 8, a mechanical locking position sensor A1 is further included, which locates position of the mechanical locking system D. The mechanical locking rings 4, 10 are provided with a detective striped plate 5, which is provided with a striped hole 51, through which a pin shaft passes and the detective striped plate 5 can rotate around the pin shaft. The mechanical locking sensor A1 adopts a mechanically triggered sensor, which is triggered at different position during movements, so that positioning is realized.

As shown in FIG. 1 to 8, an electrical locking position sensor A2 is further included, which locates the state position of the electrical locking system C. The electrical locking position sensor A2 may adopt a mechanically triggered sensor. The electrical locking position sensor A2 locates the position of a motored jamming hook 19.

The mechanical locking position sensor A1 and the electrical locking position sensor A2 form together a sensor system A.

As shown in FIG. 1 to 8, 10, 11 and 12, the mechanical locking system D comprises mechanical locking cams 12, 13, a compressed spring 15, a connecting sheet 14 and a mechanical locking housing 30. The connecting sheet 14 is provided with a notch, in which the compressed spring 15 lies.

The compressed spring 15 lies inside the mechanical locking housing 30 and the connecting sheet 14 reaches partially movable into the mechanical locking housing 30. One end of the connecting sheet contacts with the compressed spring 15, and the other end connects with the mechanical locking cams 12, 13 through the pin shaft. The mechanical locking cams 12, 13 match the mechanical locking rings 4, 10 and are provided with jamming protuberances 121, 131. The mechanical locking rings 4, 10 are provided with hooks, which match the jamming protuberances 121, 131. The mechanical locking housing 30 is provided with two first jamming holes 30a and the two connecting sheets 14 are provided correspondingly with second jamming holes 14a.

A working progress is described as follows: when the mechanical locking ring 4 rotates with an arc size of m in an opposite direction of unlatching, the mechanical locking ring 4 presses against the mechanical locking cam 12, which compresses the compressed spring 15 and the end of the mechanical cam 12 rotates to the rotating track of the rotatable latchbolt 16, such that the rotatable latchbolt 16 is unable to unlatch through rotation. The mechanical locking ring 10, the mechanical locking cam 13, the compressed spring 15 and the rotatable latchbolt 16 are matched in a similar manner and thus a repetition is waived here.

The engagement between the jamming protuberances 121, 131 and the hooks on the mechanical locking rings 4, 10 has the following function: when the mechanical locking rings 4, 10 rotate in the direction of opening, the hooks hook the jamming protuberances 121, 131, and thus the mechanical locking cams 12, 13 are hooked out of the rotation track of the rotatable latchbolt 16 to avoid that the mechanical locking cams 12, 13 may block the rotatable latchbolt 16 and affect the unlatching movement.

During mounting, when an inserting pin is inserted into the first jamming hole 30a and the second jamming hole 14a, one of the connecting sheets 14 is fixed, the connecting sheet 14 moves neither inwards nor outwards inside the mechanical locking housing 30. Thus, one side of the locked connecting sheet cannot lock the latchbolt by rotating the lever in the opposite direction of unlatching. In an unmounted state, neither of the two connecting sheets is locked. In a specific mounting, depending on the logic of how the room door is actually chosen, people can choose to lock one connecting sheet 14, or to lock neither of the two connecting sheets or both two connecting sheets. A selection among a variety of logic combinations is thus achieved.

As shown in FIG. 1 to 8, the motored locking system C comprises two sets of mirror symmetric transmitting mechanisms and two motored jamming hooks 19 that are mirror symmetrical, wherein both sets of the transmitting mechanisms are driven through a motor 29.

The transmitting mechanisms transmit the power of the motor 29 to the motored jamming hooks 19. Between the two sets of transmitting mechanisms, a bar 18 is provided in that the two sets of transmitting mechanisms are mirror symmetric regarding the bar 18.

The electrical locking rings 2, 9 are provided with hook parts, which match the electrical jamming hooks 19. When the electrical jamming hooks 19 hook the hook parts of the electrical locking rings 2, 9, the electrical locking rings 2, 9 are locked.

The transmitting mechanisms are gear-driven, wherein two sets of the transmitting mechanisms are provided mirrored and symmetrical on both sides of bar 18.

A transmitting mechanism comprises an input gear 26, a first middle gear 27, a second middle gear 25, a third middle gear 23 and an output gear 20. The input gear 26 and the first middle gear 27 are arranged coaxially, and the first middle gear 27, the second middle gear 25, the third middle gear 23 and the output gear 20 are engaged in sequence.

The input gear 26 is a contrate gear and the first middle gear 27 and the third middle gear are unidirectional gears.

A unidirectional rotation of the first middle gear 27 is realized by fixing a rotatable shaft on the first middle gear 27. An overrunning clutch 22 is mounted fixedly on the rotatable shaft, wherein the first middle gear 27 is attached to the overrunning clutch 22. The function of the overrunning clutch 22 lies in that the transmitting mechanism on one mirror side outputs when the motor rotates positively, and the transmitting mechanism on the other mirror side outputs when the motor rotates reversely, that is to say, on both mirror sides, the first middle gear 27 on one mirror side is driven by rotating the motor positively, while the overrunning clutch 22 that is attached to the first middle gear 27 on the other mirror side idles. Similarly, when the motor rotates reversely, only one transmitting mechanism is driven to output by rotating the motor in one direction.

A unidirectional rotation of the third middle gear 23 is realized by providing a rotatable shaft on the locking housing. An overrunning clutch 22 is attached to the rotatable shaft, wherein the third middle gear 23 is attached to the overrunning clutch 22. The middle gear 23 engages then with the output gear 20. The transmitting process is that the third middle gear 23 rotates and drives the output gear 20, the output gear 20, however, cannot drive the third middle gear 23 backwards, which successfully prevents the gears of the electrical locking system from rotating freely, which may be caused by swings of opening or closing the door.

An overrunning clutch is a basic part which appears along with the development of the mechatronic integrated products. It is an important part for transmitting and separating function between a prime mover and a working machine or between a driving shaft and a driven shaft inside a machine. It is a device having the self-clutch function by making use of velocity change of the driving part and the driven part as well as the switch of the rotation direction. An overrunning clutch may be a wedge-typed overrunning clutch, a roller-typed overrunning clutch or a ratchet-typed overrunning clutch. The overrunning clutch belongs to prior art and thus a repetition is waived here.

At last, the output gear 20 drives the motored jamming hook 19 to swing periodically.

As shown in FIG. 4, two transmitting mechanisms share a common motor 29, which is provided at its output end with a driving gear 28, which is attached to an output shaft of the motor 29. The driving gear 28 engages with both input gears 26. The working state on both sides of two motored jamming hooks 19 is described as follows: the motored jamming hook 19 on one of the mirror sides works, while the motored jamming hook 19 on the other mirror side does not work. When the motor rotates positively and reversely, the motored jamming hooks 19 on both mirror sides repeat controlling the state of the switch on the corresponding side alternatively.

As shown in FIG. 4, one end of the motored jamming hook 19 is an end of the hook part and the other end of the motored jamming hook 19 is a connecting end of the pin shaft. The motored jamming hook 19 is provided with oval through holes, which are located between the end of the hook part and the connecting end of the pin shaft. The motored jamming hook 19 swings around the pin shaft.

The front end of the output gear 20 is provided with an eccentric pillar 201, which passes through the oval through holes. When the output gear 20 rotates, the eccentric pillar 201 rotates around the fixed shaft of the output gear 20 and the eccentric pillar 201 drives the motored jamming hook 19 to swing.

The connecting end of the pin shaft of the motored jamming hook 19 triggers the motored locking position sensors A2 at different positions, so that a positioning is realized.

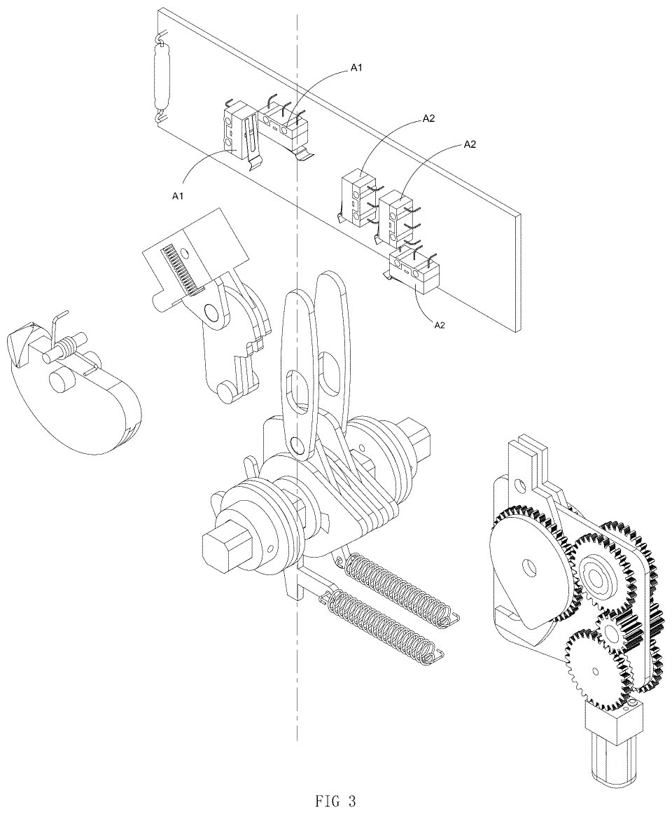

As shown in FIGS. 3, 4 and 6, the cylinder mechanism B is provided with an electrical unlocking cam 6, which rotates synchronously with the control pillars 10, 11. The motored locking system C further comprises automatic unlocking rings 21, 24. The output gear 20 and the output gear 20 rotate coaxially and synchronously. Two electrical unlocking cams 6 match the automatic unlocking rings 21, 24.

The eccentric pillar 201 is fixed on the front end of the automatic unlocking rings 21, 24 and passes through the output gear 20.

When the control pillars 8, 11 rotate in the opposite direction of unlatching, the mechanical locking rings 4, 10 moves the ends of the mechanical locking cams 12, 14 to rotate redirected to the unlocking rotation track of the rotatable latchbolt 16, so that locking of the rotatable latchbolt 16 is realized. When the motor 29 drives the motored jamming hook 19 to rotate, the automatic unlocking rings 21, 24 rotate synchronously. Two electrical unlocking cams 6 are moved separately to rotate when the automatic unlocking rings 21, 24 rotate. Two electrical unlocking cams 6 move the control pillars 8, 11 with them to turn back to the standby state, that is to say, the lever is turned back to the standby state. After the motor 29 rotates in one period, the eccentric pillar 201 moves from one end of the short shaft of the oval through holes to the other end and an one-way swing is accomplished. When the motor 29 and the automatic unlocking rings 21, 24 rotate, the electrical unlocking cams 6 are necessarily moved back to the original position, and thus an unlocking of the rotatable bolts 21, 24 by the mechanical locking cams 12, 13 are achieved.

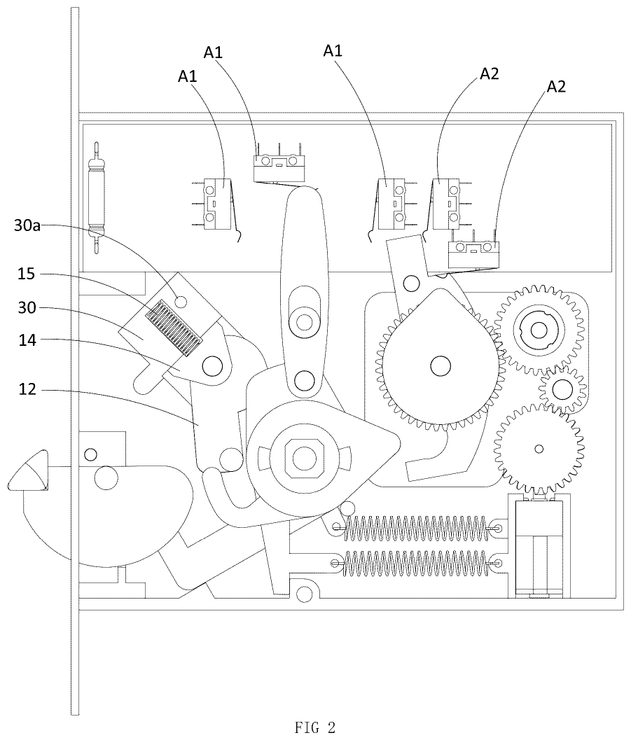

As shown in FIG. 2, the lock according to the present invention is further provided with a jamming protrusion. A jamming protrusion is provided at the rotatable latchbolt 16 to avoid an excessive rotation angle of the latchbolt during unlatching, while a jamming protrusion is provided in the opposite direction of unlocking rotating direction at the latchbolt control ring 1, a jamming protrusion is provided at the motored locking rings 2, 9. The rotating distance of a jamming hooked structure of the latchbolt control ring 1 is jammed under tension of the extension spring 3, however, the rotating distance in the unlatching direction is not limited by the protrusion.

### Second Embodiment

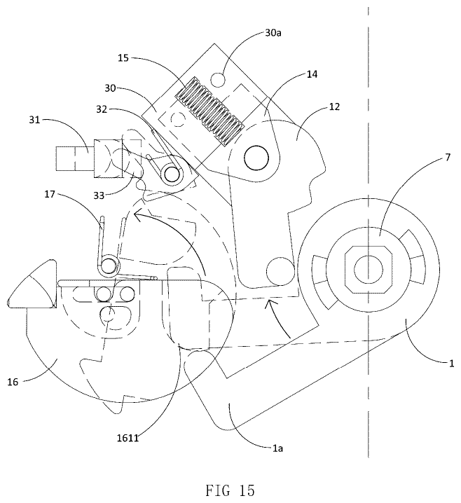

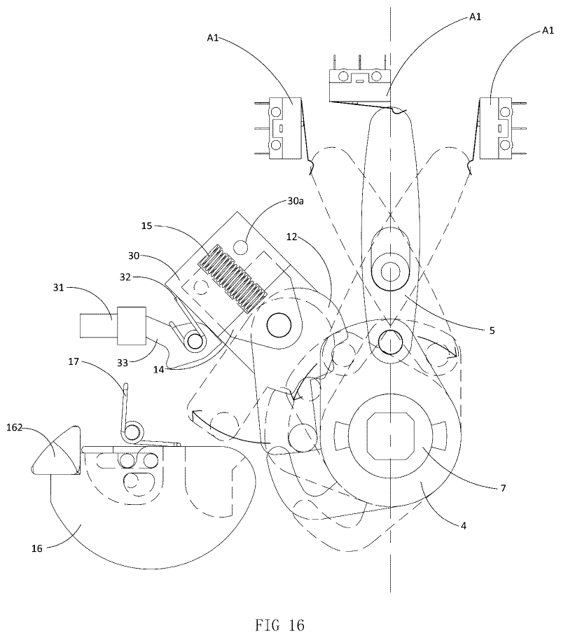

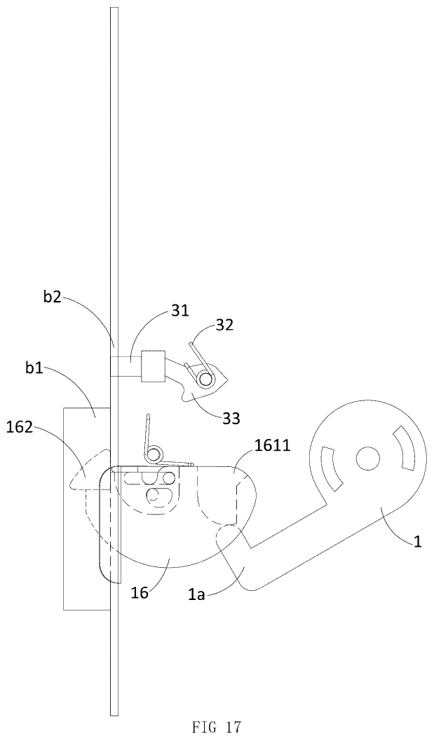

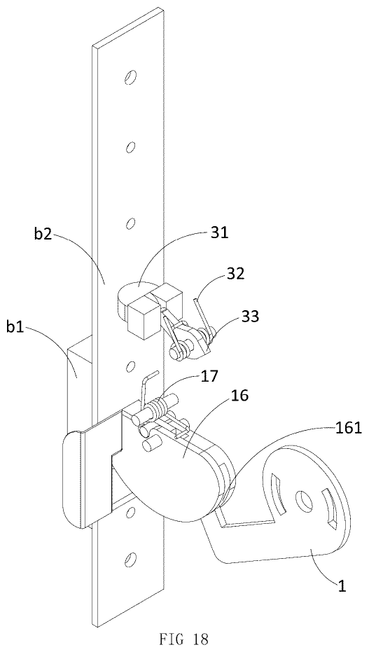

In a further embodiment, on the basis of the aforementioned embodiment, a first latchbolt synchronizer 163 and a second latchbolt synchronizer 164 are provided on one side of the latchbolt 16 and are coaxial with a latchbolt rotating shaft to prevent the electrical locking system from being bypassed by an object such as a plastic card and to prevent the door from being forcibly opened, as shown in FIG. 15 to 23. The second latchbolt synchronizer 164 is provided between the latchbolt 16 and the first latchbolt synchronizer 163. When the latchbolt 16 rotates along Z3 to lock the door, the second latchbolt synchronizer 164 synchronizes with the latchbolt 16, however extends outwards with a linear movement. In the present embodiment, the jamming protuberance 1611 on the latchbolt 16 may be concave shaped compared to that in the first embodiment and has the same function as in the first embodiment. Thus, a repetition is waived here. By adding the first latchbolt synchronizer 163 and the second latchbolt synchronizer, a telescopic member 31, a double-ended tension spring 32 and a jamming hook 33. The jamming hook 33 contacts the latchbolt 16 when the latchbolt is in an unlatched state, as shown in FIG. 16. The double-ended tension spring 32 is provided inside the jamming hook 33 with one end pressing against the jamming hook 33 and the other hand contacting the mechanical locking housing 30, such that the jamming hook 33 can move when latchbolt 16 rotates. When the jamming protuberance 1611 of the bolt 16 is passed, the jamming hook 33 jams the latchbolt 16 such that the latchbolt 16 cannot rotate outwards. The telescopic member 31 can bear force and move inwards to inside the lock when closing the door. Further, the jamming hook 33 is rotated clockwise such that the jamming hook 33 leaves the area that jams the jamming protuberance to release latchbolt 16. As shown in FIGS. 15 and 16. Meanwhile, it is worth to mention that the side of the telescopic member 31, which is away from the inside of the lock, is arc-shaped, which applies for all kinds of doors. Through the arrangement of the telescopic member 31, the double-ended tension spring 32 and the jamming hook 33, the latchbolt cannot rotate outwards when the door leaves the door frame, which thus enhances the overall harmonious impression. A latchbolt is provided to avoid jamming of rope-shape objects such as lines, belts and others due to unnecessary extending out. Meanwhile, since it is not required to resist the spring force of the latchbolt when closing the door, the door closing movement is smoother. In further technical effects, such design prevents the user from accidentally locking the latchbolt when the door is opened. If the latchbolt keeps extending out when the door is opened, certain noises appear when closing a sliding door and in case a bump into the door frame is unavoidable, which itself is a damage on the door frame. This design can partially avoid the bump from the latchbolt to the door frame. Meanwhile, the bump is concentrated on telescopic member 31. The telescopic member 31 ejects automatically after bumping into a latchbolt 16, which will not affect the resilience function of the sliding door.

A lock that does not distinguish between public and private spaces according to the present invention is explained in detail above. The description of specific embodiments is only intended to help in understanding the method and core idea of the present invention. It should be noted that the skilled person in the art can make improvements and modifications without departing from the technical principles of the present invention. These improvements and modifications should also be considered as the scope of protection of the present invention.

A cylinder and a control component according to the present invention is explained in detail above. The description of specific embodiments is only intended to help in understanding the method and core idea of the present invention. It should be noted that the skilled person in the art can make improvements and modifications without departing from the technical principles of the present invention. These improvements and modifications should also be considered as the scope of protection of the present invention.

1. A cylinder, comprising two mirror-symmetric cylinder mechanisms which jointly drive a latchbolt control ring;
wherein the latchbolt mechanism comprises an electric locking ring and a control pillar, wherein the control pillar passes through the rotation centers of the electric locking ring and the latchbolt control ring one after another;
wherein one of the two control rods is provided at its front surface with a rotatable shaft and the other is provided at the front surface with a counter bore, wherein the rotatable shaft is inserted into the counter bore and may rotate inside it, wherein the rotatable shaft passes movably through the latchbolt control ring and the latchbolt control ring may rotate around the rotatable shaft;
wherein each of the two control rods is equipped with a first control pin and a second control pin, wherein the first control pin and the second control pin circulates around the rotatable shaft, wherein the rotation direction, in which the first control pins controls the latchbolt control ring to unlatch, corresponds to the rotation direction, in which the second control pin controls the latchbolt control ring to unlatch;
wherein the first control pin passes in sequence through the electrical unlocking cam of the first mirror symmetric side, the mechanical locking ring of the first mirror symmetric side, the electrical locking ring of the first mirror symmetric side, the latchbolt control ring and the electrical locking ring of the second mirror symmetric side, wherein the electrical locking ring of the second side controls the unlocking and locking movement of the first control pin and the electrical locking ring of the first mirror symmetric side does not limit the unlatching movement of the first control pin;
wherein the second control pin passes in sequence through the electrical unlocking cam of the second mirror symmetric side, the mechanical locking ring of the second mirror symmetric side, the electrical locking ring of the second mirror symmetric side, the latchbolt control ring and the electrical locking ring of the first mirror symmetric side, wherein the electrical locking ring of the first mirror side controls the unlocking and locking movement of the second control pin and the electrical locking ring of the second mirror side does not limit the unlatching movement of the second control pin.

2. The cylinder as claimed in claim 1, characterized in that
the cylinder mechanism comprises a mechanical locking ring, wherein the mechanical locking ring and the control pillar rotate synchronously.

3. The cylinder as claimed in claim 1, characterized in that
the cylinder mechanism comprises an elastic resetting part, wherein the elastic resetting part and the control pillar form a rotational torque and the elastic resetting part tights the electrical locking ring in an opposite direction of unlatching.

4. The cylinder as claimed in claim 1, characterized in that
the first control pin and the second control pins have each a fan-shaped cross section, and the arc size of the fan shape is m;
wherein the electrical locking ring on the first mirror side is provided with two arc-shaped through holes, the arc size of one arc-shaped through hole is 2 m and the arc size of the other arc-shaped through hole is 3 m;
in case that the first control pin matches the arc-shaped through hole of the electrical locking ring on the first mirror side that has an arc size of 3 m, the first control pin may rotate at the same angle clockwise and anti-clockwise within the arc-shaped through hole of the electrical locking ring on the first mirror side without rotating the electrical locking ring on the first mirror side. When the first control pin in located in the middle of the arc-shaped through hole that has a 3 m arc size of the electrical locking ring on the first mirror side, the electrical locking ring is in the standby state;
in case that the first control pin matches the arc-shaped through hole of the latchbolt control ring that has an arc size of 2 m, the latchbolt control ring rotates therewith when the first control pin rotates in a direction of unlatching and the latchbolt control ring does not rotate therewith when the first control ring rotates with an arc size of m in an opposite direction of unlatching;
in case that the first control pin matches the arc-shaped through hole of the electrical locking ring on the second mirror side that has an arc size of 2 m, when the electrical locking ring (9) on the second mirror side is locked, the first control pin cannot rotate in a direction of unlatching, but rotate with an arc size of m in an opposite direction of unlatching.

5. A control component, comprising the cylinder as claimed in claim 1, characterized in that
the control component further comprises a motored locking mechanism, wherein the motored locking mechanism limits the rotational displacement of the electrical locking ring.

6. The control component as claimed in claim 5, characterized in that
the motored locking mechanism comprises a motor, two groups of transmission mechanisms that are arranged mirror symmetrically and two output components that are arranged mirror symmetrically, wherein the two groups of transmission mechanisms are driven by a common motor and the transmission mechanisms transmit power of the motor to the output components;
wherein an output end of the motor is provided with a driving gear, wherein the driving gear is attached to an output shaft of the motor;
wherein the two groups of transmission mechanisms further comprise each an input gear, wherein both input gears are designed as frontend gears, and wherein rotational shafts of both input gears are parallel to each other;
wherein one driving gear is engaged with both input gears, wherein the two input gears are spaced 180 degrees from each other on the circumference of the input gear.

7. The control component as claimed in claim 6, characterized in that
the transmission mechanism further comprises a middle gear and an output gear;
wherein the input gear drives the middle gear to rotate, and wherein the middle gear and the output gear engage with each other.

8. The control component as claimed in claim 7, characterized in that
the middle gear comprises a first middle gear, a second middle gear and a third middle gear, wherein the input gear and the first middle gear are fixed coaxially, and wherein the first middle gear, the second middle gear, the third middle gear and the output gears engage with each other in sequence.

9. The control component as claimed in claim 8, characterized in that
the first middle gear is provided with a rotatable shaft, wherein on the rotatable shaft is fixed attached with an overrunning clutch, wherein the overrunning clutch is attached with the first middle gear.

10. The control component as claimed in claim 9, characterized in that
the third middle gear puts output to the output gear unidirectionally.

11. The control component as claimed in claim 10, characterized in that
the rotatable shaft is provided on a locking shell, wherein an overrunning clutch is attached to the rotatable shaft, wherein the third middle gear is further attached to the overrunning clutch.

12. The control component as claimed in claim 6, characterized in that
the output component is designed as a motored jamming hook, wherein one end of the motored jamming hook is designed as a hook end and the other end is a pin shaft connecting end, wherein the motored jamming hook is provided with an oval through hole, wherein the motored jamming hook swings around the pin shaft connecting end;
wherein the front end of the output gear is provided with an eccentric pillar, which passes through the oval through holes;
wherein the eccentric pillar circulates around a central shaft of the output gear when the output gear rotates, wherein the eccentric pillar drives the motored jamming hook to swing.

13. The control component as claimed in claim 6, characterized in that
the motored locking mechanism is provided with two mirror-symmetric automatic unlocking rings, wherein both mirror-symmetric automatic unlocking rings are driven by the two transmission mechanisms;
wherein the cylinder is provided with two mirror-symmetric electrical unlocking cams, wherein the electric unlocking cams and the control pillar rotate synchronously:
wherein the automatic unlocking rings trigger the electric unlocking cams to rotate when an extruding portion of the electric unlocking cams falls on the rotation track of the extruding portion of the automatic unlocking rings.
